(19) United States
(12) Patent Application Publication
(10) Pub. No.: US 2016/0370964 A1
(43) Pub. Date: Dec. 22, 2016

(54) INFORMATION PROCESSING METHOD AND DEVICE

(71) Applicant: Beijing Zhigu Rui Tuo Tech Co., Ltd, Beijing (CN)

(72) Inventor: Kuifei Yu, Beijing (CN)

(21) Appl. No.: 15/185,010

(22) Filed: Jun. 16, 2016

(30) Foreign Application Priority Data
Jun. 19, 2015 (CN) 201510345011.8

(51) Int. Cl. G06F 3/0484; G06F 3/041; G06F 3/0488

(52) U.S. Cl. CPC G06F 3/0484; G06F 3/04883; G06F 3/0416; G06F 2203/04104

(57) ABSTRACT

An information processing method and device are provided that relate to the field of information input. A method comprises, in response to determining that a user performs a touch-sensitive input operation on a touch screen of a device, acquiring contact positions between a finger of the user and an opposite face of the touch screen in different times; and at least in response to determining that the contact positions between the finger and the opposite face of the touch screen in different times satisfy a first predetermined condition, adjusting an input mode of the device. According to the contact positions between the finger of the user and an opposite face of the touch screen, it can be inferred whether or not the user encounters inconvenient input and timely adjust an input mode of the device, which facilitates user input in the event of maintaining lower power consumption.

### RELATED APPLICATION

The present application claims the benefit of priority to Chinese Patent Application No. 201510345011.8, filed on Jun. 19, 2015, and entitled “Interaction Method between Pieces of Equipment and User Equipment”, which application is hereby incorporated into the present application by reference herein in its entirety.

### TECHNICAL FIELD

The present application relates to the field of information input, and, for example, to an information processing method and device.

### BACKGROUND

With popularization of electronic devices, a growing number of touch screen devices such as smartphones and tablet computers enter into people's life, which greatly enriches people's life.

On a large touch screen phone, when only one hand (the other hand is occupied by other affairs) of the user can be configured to interact with a handheld device, it is possible to result in that the input process is slow and the input efficiency is lower as a region to be touched is too distant. To increase the input efficiency, some devices, in addition to touch-sensitive input, provide more modal input manners, for example, input information is received by detecting eye movement, blowing air streams and the like.

The more modal input manners, if opened all the time, may lead to excessive device power consumption and affect endurance time.

### SUMMARY

An example, non-limiting objective of the present application is to provide an information processing method and device.

According to one aspect of at least one example embodiment of the present application, an information processing method is provided, the method comprising:

in response to that a user performs a touch-sensitive input operation on a touch screen of a device, acquiring at least two contact positions between at least one finger of the user and an opposite face of the touch screen in different times; and

at least in response to that the at least two contact positions between the at least one finger and the opposite face of the touch screen in different times satisfy a first predetermined condition, adjusting an input mode of the device.

According to another aspect of at least one example embodiment of the present application, an information processing device is provided, the device comprising:

a first acquisition module, configured to, in response to that a user performs a touch-sensitive input operation on a touch screen of a device, acquire at least two contact positions between at least one finger of the user and an opposite face of the touch screen in different times; and

an adjustment module, configured to, at least in response to that the at least two contact positions between the at least one finger and the opposite face of the touch screen in different times satisfy a first predetermined condition, adjust an input mode of the device.

According to another aspect of at least one example embodiment of the present application, a user equipment is provided, the equipment comprising:

a touch screen;

a memory, configured to store an instruction;

a processor, configured to execute the instruction stored in the memory, the instruction causing the processor to perform the following operations of:

in response to that a user performs a touch-sensitive input operation on a touch screen of a device, acquiring at least two contact positions between at least one finger of the user and an opposite face of the touch screen in different times; and

at least in response to that the at least two contact positions between the at least one finger and the opposite face of the touch screen in different times satisfy a first predetermined condition, adjusting an input mode of the user equipment.

The information processing method and device according to example embodiments of the present application, in response to that a user performs a touch-sensitive input operation on a touch screen of a device, acquire at least two contact positions between at least one finger of the user and an opposite face of the touch screen in different times; and at least in response to that the at least two contact positions between the at least one finger and the opposite face of the touch screen in different times satisfy a first predetermined condition, adjust an input mode of the device. The information processing method and device, according to at least two contact positions between at least one finger of the user and an opposite face of the touch screen, infer whether or not the user encounters inconvenient input and timely adjust an input mode of the device, which facilitates user input.

### BRIEF DESCRIPTION OF THE DRAWINGS

FIG. 1 is a flowchart of the information processing method according to an example embodiment of the present application;

FIG. 2 is a module diagram of the information processing device according to an example embodiment of the present application;

FIG. 3 is a module diagram of the adjustment module in one example embodiment of the present application;

FIG. 4 is a module diagram of the adjustment sub-module in one example embodiment of the present application;

FIG. 5 is a module diagram of the adjustment unit in one example embodiment of the present application;

FIG. 6 is a module diagram of the information processing device in one example embodiment of the present application;

FIG. 7 is a module diagram of the information processing device in another example embodiment of the present application; and

FIG. 8 is a schematic diagram of a hardware structure of the user equipment according to an example embodiment of the present application.

### DETAILED DESCRIPTION

Example embodiments of the present application are further described below in detail with reference to the accompanying drawings and embodiments. The following embodiments are used for describing the present application, but are not intended to limit the scope of the present application.

It should be understood by a person skilled in the art that, in the embodiments of the present application, the value of the serial number of each step described below does not mean an execution sequence, and the execution sequence of each step should be determined according to the function and internal logic thereof, and should not be any limitation to the implementation procedure of the embodiments of the present application.

When a gripping hand of a user performs touch-sensitive input on a large-screen device (e.g., a mobile phone or a tablet PC), if input is inconvenient, for example, the position to be touch-sensitive is too distant, the gesture of the gripping hand may be changed habitually, for example, the gripping hand is moved towards the position to be touch-sensitive.

Meanwhile, existing electronic devices generally have lots of input manners in addition to the touch-sensitive input and their input regions may also be adjusted, for example, the input manner may also be voice input, or image input is acquired through a camera, airflow input blown by the user is received and the like. The input manners may be used as important supplements to the touch-sensitive input, which provides more input options for the user in the event that the user's touch-sensitive input encounters inconvenient input. However, the input manners generally have higher power consumption, and opening all the time will seriously affect endurance and computing performance of the device.

The present application achieves an information processing method based on the usage habits, so as to adjust an input mode of the device at a reasonable time, which reduces power consumption while facilitating user input.

FIG. 1 is a flowchart of the information processing method according to an embodiment of the present application; the method may be implemented on, for example, an information processing device. As shown in FIG. 1, the method comprises:

S120: in response to that a user performs a touch-sensitive input operation on a touch screen of a device, acquiring at least two contact positions between at least one finger of the user and an opposite face of the touch screen in different times; and

S140: at least in response to that the at least two contact positions between the at least one finger and the opposite face of the touch screen in different times satisfy a first predetermined condition, adjusting an input mode of the device.

The method according to the embodiment of the present application, in response to that a user performs a touch-sensitive input operation on a touch screen of a device, acquires at least two contact positions between at least one finger of the user and an opposite face of the touch screen in different times; and at least in response to that the at least two contact positions between the at least one finger and the opposite face of the touch screen in different times satisfy a first predetermined condition, adjusts an input mode of the device. The method, according to at least two contact positions between at least one finger of the user and an opposite face of the touch screen, infers whether or not the user encounters inconvenient input and timely adjusts an input mode of the device, which facilitates user input.

Functions of steps S120 and S140 are described below in detail with reference to example embodiments.

S120: In response to that a user performs a touch-sensitive input operation on a touch screen of a device, acquire at least two contact positions between at least one finger of the user and an opposite face of the touch screen in different times.

The device may be any electronic device comprising the touch screen, which, for example, may be a smartphone, a tablet computer, a wearable device or the like.

The touch screen may be any types of touch screens such as a vector pressure sensing technology touch screen, a resistance technology touch screen, a capacitance technology touch screen, an infrared technology touch screen and a surface acoustic wave technology touch screen.

The touch-sensitive input operation is a click input operation of a control finger of the user on the touch screen, which is not limited to the user's single click, and may be a series of clicking operations, for example, the user continuously clicks multiple times during the game.

The opposite face of the touch screen is one face opposite to the screen that the user currently touches. In terms of general devices only with one screen, the opposite face is the back; for devices with two screens, for example, the existing dual-screen mobile phones, the opposite face is actually the other screen except the touch screen.

The contact position may be acquired by using a corresponding sensor located on the opposite face, for example, the sensor may be a pressure sensor, or in the event that the device is a double-touch-screen device, it is feasible to directly use the touch screen on the opposite face for acquisition.

In one example embodiment, step S120 may further comprise:

S120′: in response to that a gripping hand of the user performs the touch-sensitive input operation for different positions of the touch screen, acquiring at least two contact positions between at least one finger of the gripping hand and an opposite face of the touch screen in different times.

In the example embodiment, only when the gripping hand performs the reference input operation for different positions of the touch screen, can the method be begun, and then it is possible to adjust the input mode of the device. Thus, it is possible to overcome the problem that execution of the method may lead to false triggering under some circumstances. For example, in the event that one hand grips the device while the other hand touches and inputs, or in the event that the touch-sensitive position of the control hand is kept unchanged, the method may not be performed.

S140: At least in response to that the at least two contact positions between the at least one finger and the opposite face of the touch screen in different times satisfy a first predetermined condition, adjust an input mode of the device.

The adjusting an input mode of the device may comprise: adjusting an input manner and/or an input region of the device.

The input manner may comprise: touch-sensitive input, voice input, image input, airflow input, bending deformation input and the like. The image input, for example, may achieve input by detecting eye movement. The airflow input, for example, may achieve input by detecting airflow blown by the user to the device. The bending deformation input, for example, may achieve input by changing the shape of the device. The adjusting an input manner herein may be opening more input manners, for example, while the touch-sensitive input has been opened, the voice input is opened; or, it is also feasible to switch input manners, for example, the input manner is switched from the touch-sensitive input to the voice input.

The adjusting an input region of the device, for example, may be adjusting full-screen input to region input, for example, a screen region close to the control finger of the user is set as an input region, to facilitate user input.

In one example embodiment, step S140 may comprise:

S141: determining respective movement distance related information of the at least one finger according to the at least two contact positions between the at least one finger and the opposite face of the touch screen in different times; and

S142: at least in response to that the respective movement distance related information of the at least one finger satisfies a second predetermined condition, adjusting the input mode of the device.

In step S141, the respective movement distance related information of the at least one finger may be multiple movement distances corresponding to each finger, for example, a movement distance corresponding to each change of the contact position of each finger; the respective movement distance related information of the at least one finger may also be the variance of multiple movement distances corresponding to each finger.

In one example embodiment, step S142 may comprise:

S1421: determining respective maximum movement distances of the at least one finger according to the respective movement distance related information of the at least one finger; and

S1422: in response to that the respective maximum movement distances of the at least one finger satisfy a third predetermined condition, adjusting the input mode of the device.

In step S1421, it is feasible to select the maximum one from multiple movement distances of one finger as the maximum movement distance of the finger, and similarly, it is feasible to obtain respective maximum movement distances of the at least one finger.

In step S1422, it is feasible to adjust the input mode of the device in the event that any one of the respective maximum movement distances of the at least one finger is greater than a predetermined value. That is to say, if the maximum movement distance of only one finger is great enough, it is considered that the third predetermined condition is satisfied, and then it is inferred that it is inconvenient for the user to make current input and it is necessary to adjust the input mode.

In another example embodiment, to avoid misjudgment, step S1422 may further comprise:

S14221: determining an average movement distance of the at least one finger according to the respective maximum movement distances of the at least one finger; and

S14222: in response to that the average movement distance is greater than a threshold, adjusting the input mode of the device.

In step S14221, the average movement distance of the at least one finger is obtained by summing the maximum movement distance of each finger and then dividing the number of the at least one finger.

In step S14222, in the event that the number of the at least one finger is more, the average movement distance is compared with the threshold, and the input mode is adjusted based on a comparison result, which actually determines the time of adjusting the input mode of the device comprehensively according to maximum movement distances of multiple fingers, and compared with determining the time of adjusting the input mode simply according to the maximum movement distance of a certain finger, can reduce misjudgment and increase accuracy.

In another example embodiment, step S142 may comprise:

S142′: in response to that a classification result of the respective movement distance related information of the at least one finger based on a classifier is that it is necessary to adjust the input mode of the device, adjusting the input mode of the device.

In the example embodiment, in essence, the respective movement distance related information of the at least one finger is classified based on a classifier, and a classification result is obtained, the classification result comprising: it is necessary to adjust the input mode of the device, or it is not necessary to adjust the input mode of the device. In the event that the classification result is that it is necessary to adjust the input mode of the device, the input mode of the device is adjusted.

The classifier may be generated based on training data of the user, for example, in the training stage, contact positions between fingers of the gripping hand of the user and the opposite face within a period of time are recorded, multiple movement distances corresponding to each finger and/or the variance of the multiple movement distances are obtained through calculation, and then the multiple movement distances and/or the variance of the multiple movement distances as well as a corresponding classification mark are taken as a set of training data. If the user encounters inconvenient input within the period of time, the corresponding classification mark is that it is necessary to adjust the input mode of the device; if the user does not encounter inconvenient input within the period of time, the corresponding classification mark is that it is not necessary to adjust the input mode of the device. Similarly, it is feasible to obtain multiple sets of training data based on records of multiple time periods, and then it is feasible to obtain the classifier through training based on a training model such as a support vector machine (SVM) or a decision tree.

In another example embodiment, the method may further comprise:

S131: acquiring at least two touch-sensitive positions corresponding to the touch-sensitive input operation; and

S132: determining touch-sensitive distance related information according to the at least two touch-sensitive positions.

Step S142 further comprises:

S142″: in response to that a classification result of the respective movement distance related information of the at least one finger and the touch-sensitive distance related information based on a classifier is that it is necessary to adjust the input mode of the device, adjusting the input mode of the device.

A main difference between the example embodiment and the previous example embodiment is that the classifier increases classification on the touch-sensitive distance related information.

The touch-sensitive distance related information may comprise the distance between each two in the at least two touch-sensitive positions, which, in essence, reflects the size of the region that the user needs to touch-sensitive currently; evidently, the greater the distance is, the greater the region is, and correspondingly, it is more possible that the user encounters inconvenient input; on the contrary, if the distance is smaller, for example, the user clicks one position multiple times, the user generally may not encounter inconvenient input (even if it is inconvenient, the user may also easily overcome it through one hold adjustment, and generally it is not necessary to adjust the input mode). Therefore, in the example embodiment, the movement distance related information and the touch-sensitive distance related information are classified at the same time, and the classification result may be more accurate.

In the example embodiment, the classifier may also be generated based on training data of the user, for example, in the training stage, contact positions between fingers of the gripping hand of the user and the opposite face within a period of time are recorded, multiple movement distances corresponding to each finger are obtained through calculation, touch-sensitive positions of the user for the touch screen within the period of time are recorded at the same time, the touch-sensitive distance between each two touch-sensitive positions are obtained through calculation, and then the multiple movement distances and/or the variance of the multiple movement distances, the touch-sensitive distances as well as a corresponding classification mark are taken as a set of training data. If the user encounters inconvenient input within the period of time, the corresponding classification mark is that it is necessary to adjust the input mode of the device; if the user does not encounter inconvenient input within the period of time, the corresponding classification mark is that it is not necessary to adjust the input mode of the device. Similarly, it is feasible to obtain multiple sets of training data based on records of multiple time periods, and then it is feasible to obtain the classifier through training based on a training model such as a SVM or a decision tree.

As stated previously, it is feasible to obtain the movement distance related information according to the at least two contact positions between the at least one finger and the opposite face of the touch screen in different times, and then it is feasible to determine whether it is necessary to adjust the input mode currently based on a pre-trained classifier. It can be considered that the movement distance related information directly decides whether it is necessary to adjust the input mode, and at the same time, the at least two contact positions between the at least one finger and the opposite face of the touch screen in different times decide the movement distance related information. Therefore, in one example embodiment, it is feasible to determine whether it is necessary to adjust the input mode directly according to the at least two contact positions between the at least one finger and the opposite face of the touch screen in different times and the corresponding classifier. In the example embodiment, step S140 further comprises:

S140′: in response to that a classification result of the at least two contact positions between the at least one finger and the opposite face of the touch screen in different times based on a classifier is that it is necessary to adjust the input mode of the device, adjusting the input mode of the device.

In the example embodiment, the classifier may also be generated based on training data of the user, for example, in the training stage, contact positions between fingers of the gripping hand of the user and the opposite face within a period of time are recorded, and corresponding classification marks are taken as a set of training data. If the user encounters inconvenient input within the period of time, the corresponding classification mark is that it is necessary to adjust the input mode of the device; if the user does not encounter inconvenient input within the period of time, the corresponding classification mark is that it is not necessary to adjust the input mode of the device. Similarly, it is feasible to obtain multiple sets of training data based on records of multiple time periods, and then it is feasible to obtain the classifier through training based on a training model such as a SVM or a decision tree.

As stated previously, the touch-sensitive distance related information may also affect accuracy of the classification result, and the touch-sensitive positions decide the touch-sensitive distance related information; in another example embodiment, the method further comprises:

S130″: acquiring at least two touch-sensitive positions corresponding to the touch-sensitive input operation; and

Step S140 further comprises:

S140″: in response to that a classification result of the at least two contact positions between the at least one finger and the opposite face of the touch screen in different times and the at least two touch-sensitive positions based on a classifier is that it is necessary to adjust the input mode of the device, adjusting the input mode of the device.

In the example embodiment, the classifier may also be generated based on training data of the user, for example, in the training stage, contact positions between fingers of the gripping hand of the user and the opposite face within a period of time are recorded, touch-sensitive positions of the user's control hand for the touch screen within the period of time are recorded at the same time, and then the contact positions, the touch-sensitive positions as well as a corresponding classification mark are taken as a set of training data. If the user encounters inconvenient input within the period of time, the corresponding classification mark is that it is necessary to adjust the input mode of the device; if the user does not encounter inconvenient input within the period of time, the corresponding classification mark is that it is not necessary to adjust the input mode of the device. Similarly, it is feasible to obtain multiple sets of training data based on records of multiple time periods, and then it is feasible to obtain the classifier through training based on a training model such as a SVM or a decision tree.

Under some circumstances, after the user performs the touch-sensitive input operation, in a next period of time, it is not necessary to input information; in this case, if the input mode of the device is adjusted, display is not necessary. Therefore, in one example embodiment, step S140 may further comprise:

S140′″: in response to that the at least two contact positions between the at least one finger and the opposite face of the touch screen in different times satisfy the first predetermined condition and that input receiving state information of the device satisfies a fourth predetermined condition, adjusting the input mode of the device.

The input receiving state information may be directly acquired from the device, which reflects whether the device is preparing to receive user input currently. For example, the device currently displays one input region, and evidently, the device is preparing to receive user input currently; on the contrary, if the device is currently in a lock-screen state, the device generally does not prepare to receive user input.

In the example embodiment, the second predetermined condition may be that the input receiving state information displays that the device is preparing to receive user input currently.

In addition, an embodiment of the present application further provides a computer readable medium, comprising a computer readable instruction that performs the following operations when being executed: performing the operations of steps S120 and S140 of the method in the example embodiment shown in FIG. 1.

To sum up, the method, according to at least two contact positions between at least one finger of the user and an opposite face of the touch screen, as well as touch-sensitive positions of the user for the touch screen and input receiving state information of the device, infer whether or not the user encounters inconvenient input and timely adjust an input mode of the device, thus facilitating user input in the event of maintaining lower power consumption.

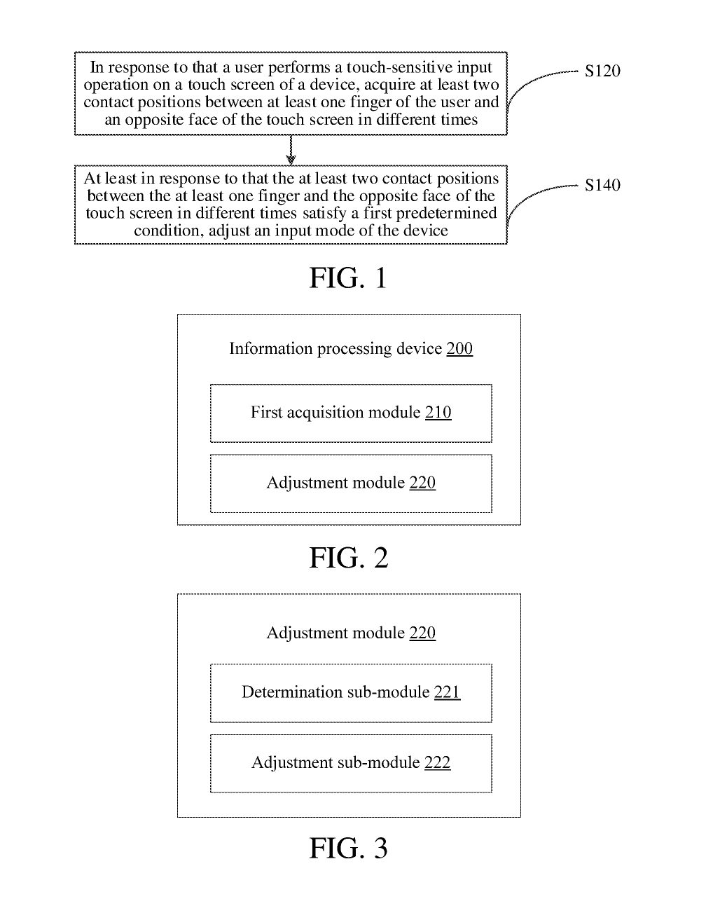

FIG. 2 is a module diagram of the information processing device according to an embodiment of the present application; the information processing device may be disposed in a user equipment such as a smartphone as a functional module, and certainly may also be used by the user as a separate terminal device. As shown in FIG. 2, the information processing device 200 may comprise:

a first acquisition module 210, configured to, in response to that a user performs a touch-sensitive input operation on a touch screen of a device, acquire at least two contact positions between at least one finger of the user and an opposite face of the touch screen in different times; and

an adjustment module 220, configured to, at least in response to that the at least two contact positions between the at least one finger and the opposite face of the touch screen in different times satisfy a first predetermined condition, adjust an input mode of the device.

The information processing device according to the embodiments of the present application, in response to that a user performs a touch-sensitive input operation on a touch screen of a device, acquires at least two contact positions between at least one finger of the user and an opposite face of the touch screen in different times; and at least in response to that the at least two contact positions between the at least one finger and the opposite face of the touch screen in different times satisfy a first predetermined condition, adjusts an input mode of the device. The information processing device, according to at least two contact positions between at least one finger of the user and an opposite face of the touch screen, infers whether or not the user encounters inconvenient input and timely adjusts an input mode of the device, which facilitates user input.

The information processing device may be the same as the device and may also be different from the device. In the case that they are different, the information processing device may communicate with the device, to acquire information such as the at least two contact positions between the at least one finger and the opposite face of the touch screen in different times.

Functions of the first acquisition module 210 and the adjustment module 220 are described below in detail with reference to example embodiments.

The first acquisition module 210, configured to, in response to that a user performs a touch-sensitive input operation on a touch screen of a device, acquire at least two contact positions between at least one finger of the user and an opposite face of the touch screen in different times.

The device may be any electronic device comprising the touch screen, which, for example, may be a smartphone, a tablet computer, a wearable device or the like.

The touch screen may be any types of touch screens such as a vector pressure sensing technology touch screen, a resistance technology touch screen, a capacitance technology touch screen, an infrared technology touch screen and a surface acoustic wave technology touch screen.

The touch-sensitive input operation is that the user controls a finger to perform a click input operation on the touch screen, which is not limited to the user's single click, and may be a series of clicking operations, for example, the user continuously clicks multiple times during the game.

The opposite face of the touch screen is one face opposite to the screen that the user currently touches. In terms of general devices only with one screen, the opposite face is the back; for devices with two screens, for example, the existing dual-screen mobile phones, the opposite face is actually the other screen except the touch screen.

The contact position may be acquired by using a corresponding sensor located on the opposite face, for example, the sensor may be a pressure sensor, or in the event that the device is a double-touch-screen device, it is feasible to directly use the touch screen on the opposite face for acquisition.

In one example embodiment, the first acquisition module 210 is configured to, in response to that a gripping hand of the user performs the touch-sensitive input operation for different positions of the touch screen, acquire at least two contact positions between at least one finger of the gripping hand and an opposite face of the touch screen in different times.

In the example embodiment, only when the gripping hand performs the reference input operation for different positions of the touch screen, can the method be begun, and then it is possible to adjust the input mode of the device. Thus, it is possible to overcome the problem that execution of the method may lead to false triggering under some circumstances. For example, in the event that one hand grips the device while the other hand touches and inputs, or in the event that the touch-sensitive position of the control hand is kept unchanged, the method may not be performed.

The adjustment module 220, configured to, at least in response to that the at least two contact positions between the at least one finger and the opposite face of the touch screen in different times satisfy a first predetermined condition, adjust an input mode of the device.

The adjusting an input mode of the device may comprise: adjusting an input manner and/or an input region of the device.

The input manner may comprise: touch-sensitive input, voice input, image input, airflow input, bending deformation input and the like. The adjusting an input manner herein may be opening more input manners, for example, while the touch-sensitive input has been opened, the voice input is opened; or, it is also feasible to switch input manners, for example, the input manner is switched from the touch-sensitive input to the voice input.

The adjusting an input region of the device, for example, may be adjusting full-screen input to region input, for example, a screen region close to the control finger of the user is set as an input region, to facilitate user input.

In one example embodiment, referring to FIG. 3, the adjustment module 220 may comprise:

a determination sub-module 221, configured to determine respective movement distance related information of the at least one finger according to the at least two contact positions between the at least one finger and the opposite face of the touch screen in different times; and

an adjustment sub-module 222, configured to, in response to that the respective movement distance related information of the at least one finger satisfies a second predetermined condition, adjust the input mode of the device.

The respective movement distance related information of the at least one finger may be multiple movement distances corresponding to each finger, for example, a movement distance corresponding to each change of the contact position of each finger; the respective movement distance related information of the at least one finger may also be the variance of multiple movement distances corresponding to each finger.

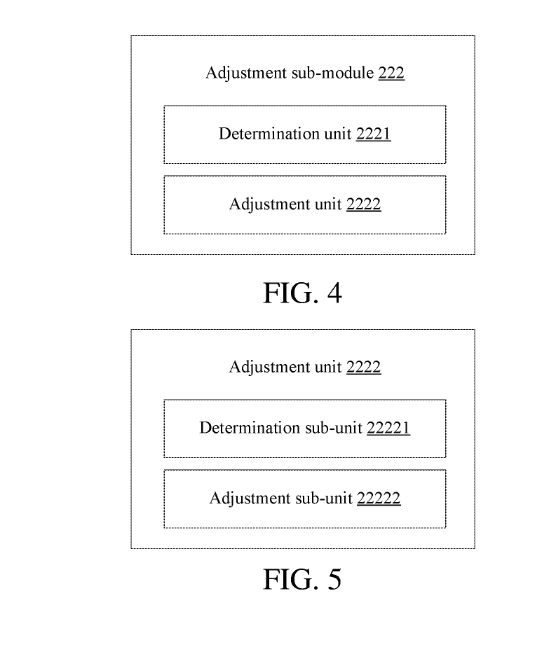

In one example embodiment, referring to FIG. 4, the adjustment sub-module 222 may comprise:

a determination unit 2221, configured to determine respective maximum movement distances of the at least one finger according to the respective movement distance related information of the at least one finger; and

an adjustment unit 2222, configured to, in response to that the respective maximum movement distances of the at least one finger satisfy a third predetermined condition, adjust the input mode of the device.

The determination unit 2221 may select the maximum one from multiple movement distances of one finger as the maximum movement distance of the finger, and similarly, it is feasible to obtain respective maximum movement distances of the at least one finger.

The adjustment unit 2222 may adjust the input mode of the device in the event that any one of the respective maximum movement distances of the at least one finger is greater than a predetermined value. That is to say, if the maximum movement distance of only one finger is great enough, it is considered that the third predetermined condition is satisfied, and then it is inferred that it is inconvenient for the user to make current input and it is necessary to adjust the input mode.

Referring to FIG. 5, in another example embodiment, to avoid misjudgment, the adjustment unit 2222 may further comprise:
a determination sub-unit 22221, configured to determine an average movement distance of the at least one finger according to the respective maximum movement distances of the at least one finger; and

an adjustment sub-unit 22222, configured to, in response to that the average movement distance is greater than a threshold, adjust the input mode of the device.

The determination sub-unit 22221 may, for example, obtain the average movement distance of the at least one finger by summing the maximum movement distance of each finger and then dividing the number of the at least one finger.

The adjustment sub-unit 22222, in the event that the number of the at least one finger is more, compares the average movement distance with the threshold, and adjusts the input mode based on a comparison result, which actually determines the time of adjusting the input mode of the device comprehensively according to maximum movement distances of multiple fingers, and compared with determining the time of adjusting the input mode simply according to the maximum movement distance of a certain finger, can reduce misjudgment and increase accuracy.

In another example embodiment, the adjustment sub-module 222 is configured to, in response to that a classification result of the respective movement distance related information of the at least one finger based on a classifier is that it is necessary to adjust the input mode of the device, adjust the input mode of the device.

In the example embodiment, in essence, the respective movement distance related information of the at least one finger is classified based on a classifier, and a classification result is obtained, the classification result comprising: it is necessary to adjust the input mode of the device, or it is not necessary to adjust the input mode of the device. In the event that the classification result is that it is necessary to adjust the input mode of the device, the input mode of the device is adjusted.

The classifier may be generated based on training data of the user, for example, in the training stage, contact positions between fingers of the gripping hand of the user and the opposite face within a period of time are recorded, multiple movement distances corresponding to each finger and/or the variance of the multiple movement distances are obtained through calculation, and then the multiple movement distances and/or the variance of the multiple movement distances as well as a corresponding classification mark are taken as a set of training data. If the user encounters inconvenient input within the period of time, the corresponding classification mark is that it is necessary to adjust the input mode of the device; if the user does not encounter inconvenient input within the period of time, the corresponding classification mark is that it is not necessary to adjust the input mode of the device. Similarly, it is feasible to obtain multiple sets of training data based on records of multiple time periods, and then it is feasible to obtain the classifier through training based on a training model such as a SVM or a decision tree.

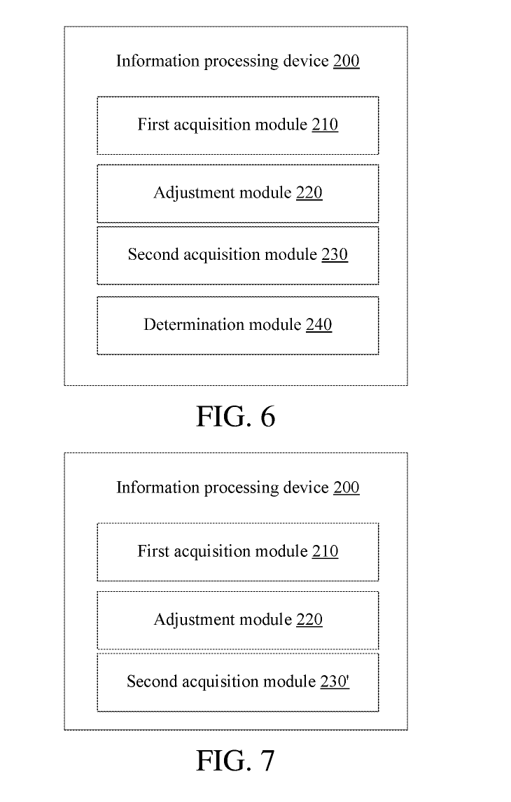

In another example embodiment, referring to FIG. 6, the information processing device 200 further comprises:

a second acquisition module 230, configured to acquire at least two touch-sensitive positions corresponding to the touch-sensitive input operation; and

a determination module 240, configured to determine touch-sensitive distance related information according to the at least two touch-sensitive positions; and

the adjustment sub-module 222 is configured to, in response to that a classification result of the respective movement distance related information of the at least one finger and the touch-sensitive distance related information based on a classifier is that it is necessary to adjust the input mode of the device, adjust the input mode of the device.

A main difference between the example embodiment and the previous example embodiment is that the classifier increases classification on the touch-sensitive distance related information.

The touch-sensitive distance related information may comprise the distance between each two in the at least two touch-sensitive positions, which, in essence, reflects the size of the region that the user needs to touch-sensitive currently; evidently, the greater the distance is, the greater the region is, and correspondingly, it is more possible that the user encounters inconvenient input; on the contrary, if the distance is smaller, for example, the user clicks one position multiple times, the user generally may not encounter inconvenient input (even if it is inconvenient, the user may also easily overcome it through one hold adjustment, and generally it is not necessary to adjust the input mode). Therefore, in the example embodiment, the movement distance related information and the touch-sensitive distance related information are classified at the same time, and the classification result may be more accurate.

In the example embodiment, the classifier may also be generated based on training data of the user, for example, in the training stage, contact positions between fingers of the gripping hand of the user and the opposite face within a period of time are recorded, multiple movement distances corresponding to each finger are obtained through calculation, touch-sensitive positions of the user for the touch screen within the period of time are recorded at the same time, the touch-sensitive distance between each two touch-sensitive positions are obtained through calculation, and then the multiple movement distances and/or the variance of the multiple movement distances, the touch-sensitive distances as well as a corresponding classification mark are taken as a set of training data. If the user encounters inconvenient input within the period of time, the corresponding classification mark is that it is necessary to adjust the input mode of the device; if the user does not encounter inconvenient input within the period of time, the corresponding classification mark is that it is not necessary to adjust the input mode of the device. Similarly, it is feasible to obtain multiple sets of training data based on records of multiple time periods, and then it is feasible to obtain the classifier through training based on a training model such as a SVM or a decision tree.

As stated previously, it is feasible to obtain the movement distance related information according to the at least two contact positions between the at least one finger and the opposite face of the touch screen in different times, and then it is feasible to determine whether it is necessary to adjust the input mode currently based on a pre-trained classifier. It can be considered that the movement distance related information directly decides whether it is necessary to adjust the input mode, and at the same time, the at least two contact positions between the at least one finger and the opposite face of the touch screen in different times decide the movement distance related information. Therefore, in one example embodiment, it is feasible to determine whether it is necessary to adjust the input mode directly according to the at least two contact positions between the at least one finger and the opposite face of the touch screen in different times and the corresponding classifier.

In the example embodiment, the adjustment module 220 is configured to, in response to that a classification result of the at least two contact positions between the at least one finger and the opposite face of the touch screen in different times based on a classifier is that it is necessary to adjust the input mode of the device, adjust the input mode of the device.

In the example embodiment, the classifier may also be generated based on training data of the user, for example, in the training stage, contact positions between fingers of the gripping hand of the user and the opposite face within a period of time are recorded, and corresponding classification marks are taken as a set of training data. If the user encounters inconvenient input within the period of time, the corresponding classification mark is that it is necessary to adjust the input mode of the device; if the user does not encounter inconvenient input within the period of time, the corresponding classification mark is that it is not necessary to adjust the input mode of the device. Similarly, it is feasible to obtain multiple sets of training data based on records of multiple time periods, and then it is feasible to obtain the classifier through training based on a training model such as a SVM or a decision tree.

As stated previously, the touch-sensitive distance related information may also affect accuracy of the classification result, and the touch-sensitive positions decide the touch-sensitive distance related information; in another example embodiment, referring to FIG. 7, the information processing device further comprises:

a second acquisition module 230′, configured to acquire at least two touch-sensitive positions corresponding to the touch-sensitive input operation; and

the adjustment module 220 is configured to, in response to that a classification result of the at least two contact positions between the at least one finger and the opposite face of the touch screen in different times and the at least two touch-sensitive positions based on a classifier is that it is necessary to adjust the input mode of the device, adjust the input mode of the device.

In the example embodiment, the classifier may also be generated based on training data of the user, for example, in the training stage, contact positions between fingers of the gripping hand of the user and the opposite face within a period of time are recorded, touch-sensitive positions of the user's control hand for the touch screen within the period of time are recorded at the same time, and then the contact positions, the touch-sensitive positions as well as a corresponding classification mark are taken as a set of training data. If the user encounters inconvenient input within the period of time, the corresponding classification mark is that it is necessary to adjust the input mode of the device; if the user does not encounter inconvenient input within the period of time, the corresponding classification mark is that it is not necessary to adjust the input mode of the device. Similarly, it is feasible to obtain multiple sets of training data based on records of multiple time periods, and then it is feasible to obtain the classifier through training based on a training model such as a SVM or a decision tree.

Under some circumstances, after the user performs the touch-sensitive input operation, in a next period of time, it is not necessary to input information; in this case, if the input mode of the device is adjusted, display is not necessary. Therefore, in one example embodiment, the adjustment module 220 is configured to, in response to that the at least two contact positions between the at least one finger and the opposite face of the touch screen in different times satisfy the first predetermined condition and that input receiving state information of the device satisfies a fourth predetermined condition, adjust the input mode of the device.

The input receiving state information may be directly acquired from the device, which reflects whether the device is preparing to receive user input currently.

In the example embodiment, the fourth predetermined condition may be that the input receiving state information displays that the device is preparing to receive user input currently.

One application scenario of the information processing method and device according to the embodiment of the present application may be as follows: a user, in the process of taking a bus, wants to log in to a certain website through a large-screen mobile phone, then the user pulls the handrail with one hand and grips the mobile phone with the other hand and input some personal information through a touch-sensitive phone screen to complete registration, the mobile phone displays information of the website in full screen, when the user's control finger cannot reach a region to be touch-sensitive, the user naturally changes the gripping gesture, the mobile phone detects the change of the contact position between the user's gripping hand and the back of the mobile phone, determines that current input is inconvenient to the user, and then opens a voice input function, and the user conveniently completes website registration through voice input.

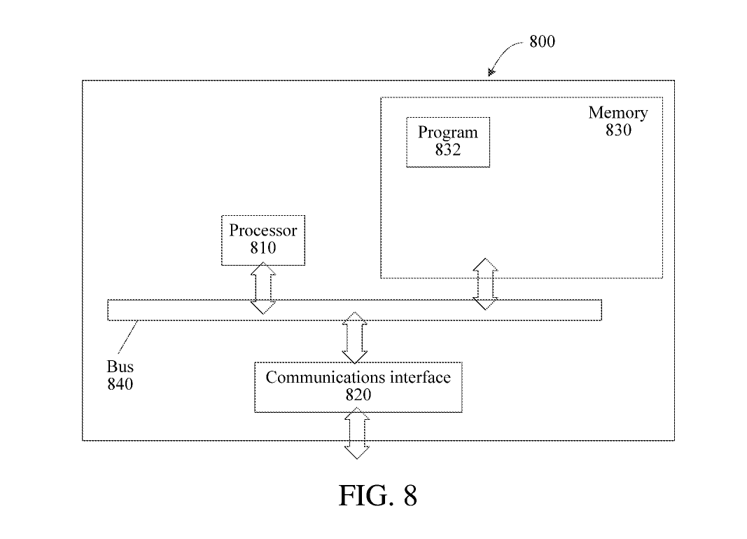

A hardware structure of a user equipment in one embodiment of the present application is as shown in FIG. 8. The specific embodiment of the present application does not define specific implementation of the user equipment. Referring to FIG. 8, the equipment 800 may comprise:

a processor 810, a communications interface 820, a memory 830, and a communications bus 840.

The processor 810, the communications interface 820, and the memory 830 communicate with each other by using the communications bus 840.

The communications interface 820 is configured to communicate with other network elements.

The processor 810 is configured to execute a program 832, and specifically, may implement relevant steps in the method embodiment shown in FIG. 1.

Specifically, the program 832 may comprise program code, the program code comprising a computer operation instruction.

The processor 810 may be a central processing unit (CPU), or an application specific integrated circuit (ASIC), or one or more integrated circuits configured to implement the embodiments of the present application.

The memory 830 is configured to store the program 832. The memory 830 may comprise a high-speed random access memory (RAM), or may also comprise a non-volatile memory, for example, at least one magnetic disk memory. The program 832 may be specifically configured to perform the following steps:

in response to that a user performs a touch-sensitive input operation on a touch screen of a device, acquiring at least two contact positions between at least one finger of the user and an opposite face of the touch screen in different times; and

at least in response to that the at least two contact positions between the at least one finger and the opposite face of the touch screen in different times satisfy a first predetermined condition, adjusting an input mode of the device.

For specific implementation of the steps in the program 832, reference may be made to corresponding description in the corresponding steps or modules in the embodiments, and no further details are provided herein again. A person skilled in the art may clearly know that, for the purpose of convenient and brief description, for a detailed working process of the foregoing device and modules, reference may be made to a corresponding process in the foregoing method embodiments, and no further details are provided herein again.

A person of ordinary skill in the art may be aware that, with reference to the examples described in the embodiments disclosed in this specification, units and method steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer-readable storage medium. Based on such an understanding, the technical solutions of the present application essentially, or the part contributing to the prior art, or a part of the technical solutions may be implemented in a form of a software product. The computer software product is stored in a storage medium, and comprises several instructions for instructing a computer device (which may be a personal computer, a controller, a network device, or the like) to perform all or a part of the steps of the methods described in the embodiments of the present application. The foregoing storage medium comprises: any medium that can store program code, such as a USB flash drive, a removable hard disk, a read-only memory (ROM, Read-Only Memory), a RAM, a magnetic disk, or an optical disc.

The foregoing example embodiments are merely used for describing the present application, rather than limiting the present application. A person of ordinary skill in the art may made various changes and modifications without departing from the spirit and scope of the present application, and therefore, all equivalent technical solutions shall belong to the scope of the present application, and the protection scope of the present application shall be subject to the claims.

What is claimed is:

1. A method, comprising:
in response to determining that a touch-sensitive input operation associated with a user identity has been initiated on a touch screen of a device comprising a processor, acquiring, by the device, contact positions between a finger of the user identity and an opposite face of the touch screen at different times; and
at least in response to determining that the contact positions between the finger and the opposite face of the touch screen at the different times satisfy a first predetermined condition, adjusting an input mode of the device.

2. The method of claim 1, wherein in response to the determining that the touch-sensitive input operation associated with the user identity has been initiated on the touch screen of the device, acquiring the contact positions between the finger of the user identity and the opposite face of the touch screen at the different times comprises:
in response to determining that a gripping hand associated with the user identity has performed the touch-sensitive input operation for different positions of the touch screen, acquiring the contact positions between the finger of the gripping hand and the opposite face of the touch screen at the different times.

3. The method of claim 1, wherein the adjusting the input mode of the device comprises:
determining respective movement distance related information of the finger according to the contact positions between the finger and the opposite face of the touch screen at the different times; and
in response to determining that the respective movement distance related information of the finger satisfies a second predetermined condition, performing the adjusting the input mode of the device.

4. The method of claim 3, wherein the adjusting the input mode of the device further comprises:
determining respective maximum movement distances of the finger according to the respective movement distance related information of the finger; and
in response to determining that the respective maximum movement distances of the finger satisfy a third predetermined condition, performing the adjusting the input mode of the device.

5. The method of claim 4, wherein the adjusting the input mode of the device further comprises:
determining an average movement distance of the finger according to the respective maximum movement distances of the finger; and
in response to determining that the average movement distance is greater than a threshold, performing the adjusting the input mode of the device.

6. The method of claim 3, wherein the adjusting the input mode of the device further comprises:
in response to determining, based on a classifier, that a classification result of the respective movement distance related information of the finger indicates to adjust the input mode of the device, performing the adjusting the input mode of the device.

7. The method of claim 3, further comprising:
acquiring touch-sensitive positions corresponding to the touch-sensitive input operation; and
determining touch-sensitive distance related information according to the touch-sensitive positions,
wherein, in response to the determining that the respective movement distance related information of the finger satisfies the second predetermined condition, the adjusting the input mode of the device further comprises:
in response to determining, based on a classifier, that a classification result of the respective movement distance related information of the finger and the touch-sensitive distance related information indicates to adjust the input mode of the device, performing the adjusting the input mode of the device.

8. The method of claim 1, wherein the adjusting the input mode of the device comprises:
in response to determining, based on a classifier, that a classification result of the contact positions between the finger and the opposite face of the touch screen at the different times indicates to adjust the input mode of the device, performing the adjusting the input mode of the device.

9. The method of claim 1, further comprising:
acquiring touch-sensitive positions corresponding to the touch-sensitive input operation,
wherein the adjusting the input mode of the device comprises:
in response to determining, based on a classifier, that a classification result of the contact positions between the finger and the opposite face of the touch screen at the different times and the touch-sensitive positions indicates to adjust the input mode of the device, performing the adjusting the input mode of the device.

10. The method of claim 1, wherein the adjusting the input mode of the device comprises:
in response to determining that the contact positions between the finger and the opposite face of the touch screen at the different times satisfy the first predetermined condition and that input receiving state information of the device satisfies a second predetermined condition, performing the adjusting the input mode of the device.

11. The method of claim 1, wherein the adjusting the input mode of the device comprises: at least one of adjusting an input manner or adjusting an input region of the device.

12. A device, comprising:
a memory that stores executable modules; and
a processor, coupled to the memory, that executes or facilitates execution of the executable modules, the executable modules comprising:
a first acquisition module configured to, in response to a first determination that a user has performed a touch-sensitive input operation on a touch screen of a device, acquire at least two contact positions between at least one finger of the user and an opposite face of the touch screen corresponding to different times; and
an adjustment module configured to, at least in response to a second determination that the at least two contact positions between the at least one finger and the opposite face of the touch screen corresponding to the different times satisfy a first predetermined condition, adjust an input mode of the device.

13. The device of claim 12, wherein the first acquisition module is configured to, in response to a third determination that a gripping hand of the user has performed the touch-sensitive input operation for the different positions of the touch screen, acquire the at least two contact positions between the at least one finger of the gripping hand and the opposite face of the touch screen corresponding to the different times.

14. The device of claim 12, wherein the adjustment module comprises:
a determination sub-module configured to determine respective movement distance related information of the at least one finger according to the at least two contact positions between the at least one finger and the opposite face of the touch screen corresponding to the different times; and
an adjustment sub-module configured to, in response to a third determination that the respective movement distance related information of the at least one finger satisfies a second predetermined condition, adjust the input mode of the device.

15. The device of claim 14, wherein the adjustment sub-module comprises:
a determination unit configured to determine respective maximum movement distances of the at least one finger according to the respective movement distance related information of the at least one finger; and
an adjustment unit configured to, in response to a fourth determination that the respective maximum movement distances of the at least one finger satisfy a third predetermined condition, adjust the input mode of the device.

16. The device of claim 15, wherein the adjustment unit comprises:
a determination sub-unit configured to determine an average movement distance of the at least one finger according to the respective maximum movement distances of the at least one finger; and
an adjustment sub-unit configured to, in response to a fifth determination that the average movement distance is greater than a threshold, adjust the input mode of the device.

17. The device of claim 14, wherein the adjustment sub-module is configured to, in response to a fourth determination that a classification result of the respective movement distance related information of the at least one finger based on a classifier is that an adjustment of the input mode of the device is to be performed, perform the adjustment of the input mode of the device.

18. The device of claim 14, wherein the executable modules further comprise:
a second acquisition module configured to acquire at least two touch-sensitive positions corresponding to the touch-sensitive input operation; and
a determination module configured to determine touch-sensitive distance related information according to the at least two touch-sensitive positions,
wherein the adjustment sub-module is configured to, in response to a fourth determination that a classification result of the respective movement distance related information of the at least one finger and the touch-sensitive distance related information based on a classifier is that an adjustment of the input mode of the device is to be performed, perform the adjustment of the input mode of the device.

19. The device of claim 12, wherein the adjustment module is configured to, in response to a third determination that a classification result of the at least two contact positions between the at least one finger and the opposite face of the touch screen corresponding to the different times based on a classifier is that an adjustment of the input mode of the device is to be performed, perform the adjustment of the input mode of the device.

20. The device of claim 12, wherein the executable modules further comprise:
a second acquisition module configured to acquire at least two touch-sensitive positions corresponding to the touch-sensitive input operation, and
wherein the adjustment module is configured to, in response to a third determination that a classification result of the at least two contact positions between the at least one finger and the opposite face of the touch screen corresponding to the different times and the at least two touch-sensitive positions based on a classifier is that an adjustment of the input mode of the device is to be performed, perform the adjustment of the input mode of the device.

21. The device of claim 12, wherein the adjustment module is configured to, in response to the second determination that the at least two contact positions between the at least one finger and the opposite face of the touch screen corresponding to the different times satisfy the first predetermined condition and that input receiving state information of the device satisfies a second predetermined condition, adjust the input mode of the device.

22. The device of claim 12, wherein the device is included in a user equipment.

23. The device of claim 12, wherein the device is a user equipment.

24. A user equipment, comprising:
a touch screen;
a memory, configured to store an instruction;
a processor, configured to execute the instruction stored in the memory, the instruction causing the processor to perform operations, comprising:
in response to a first determination that a touch-sensitive input operation has been performed on the touch screen, acquiring at least two contact positions between at least one finger of the user and an opposite face of the touch screen in different times; and
at least in response to a second determination that the at least two contact positions between the at least one finger and the opposite face of the touch screen in the different times satisfy a predetermined condition, adjusting an input mode of the user equipment.
